(19) United States
(12) Patent Application Publication
(10) Pub. No.: US 2015/0100668 A1
(43) Pub. Date: Apr. 9, 2015

(54) METHOD AND APPARATUS FOR CONTENT VERIFICATION

(71) Applicant: Samsung Electronics Co., Ltd., Suwon-si (KR)

(72) Inventors: Seog Chung SEO, Seoul (KR); Eun Ah KIM, Seoul (KR); Tae Hong KIM, Yongin-si (KR); Myeong Wuk JANG, Hwaseong-si (KR); Sang Won HYUN, Seoul (KR)

(73) Assignee: Samsung Electronics Co., Ltd., Suwon-si (KR)

(21) Appl. No.: 14/276,261

(22) Filed: May 13, 2014

(30) Foreign Application Priority Data
Oct. 4, 2013 (KR) 10-2013-0118832

(51) Int. Cl. H04L 12/26; H04L 29/08

(52) U.S. Cl. CPC H04L 43/04; H04L 67/06
USPC 709/219

(57) ABSTRACT

An intermediate node and method thereof in a network determines whether to perform verification of content at an early stage based on information about the content. The method includes receiving, from a content requesting node in the network, a request for the content, determining whether to verify the content based on information, transmitting the content to the content requesting node without verifying the content in response to the determining, and verifying the content and transmitting the content to the content requesting node in response to the determining.

### CROSS-REFERENCE TO RELATED APPLICATION

This application claims the benefit under 35 USC 119(a) of Korean Patent Application No. 10-2013-0118832, filed on Oct. 4, 2013, in the Korean Intellectual Property Office, the entire disclosure of which is incorporated herein by reference for all purposes.

### BACKGROUND

1. Field

The following description relates to a method and apparatus for content verification, and more particularly, to a method and apparatus to verify content distributed in content centric networking (CCN).

2. Description of Related Art

Content centric networking (CCN) refers to a network to which technology for providing a CCN transmission method to a data service is applied. CCN enables a more rapid and robust service to be provided against an attack on a network.

For safe distribution of content in CCN, integrity and authentication of the content needs to be verified. For example, an electronic signature may be used to verify the integrity and authentication. The electronic signature is generated using a secret key of a signer, and authenticated using a public key of the signer. The generation and authentication of the signature is based on a mathematical algorithm. Accordingly, a great amount of operational load may occur with the execution of the mathematical algorithm to generate and authenticate the signature.

A generator of the content generates the electronic signature with respect to the content by concatenating the signature to the content to securely distribute the content in CCN, and transmit the generated signature concatenated with the content. For example, network nodes of CCN receiving the content determine validity of the content by verifying the signature with respect to the content.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In accordance with an illustrative example, there is provided a method providing content by a node in a network, the method including receiving, from a content requesting node in the network, a request for the content; determining whether to verify the content based on information; transmitting the content to the content requesting node without verifying the content in response to the determining; and verifying the content and transmitting the content to the content requesting node in response to the determining.

The determining may include determining that the content is not to be verified in response to the information indicating that the content requesting node is an only node requesting the content.

The determining may include determining that the content is to be verified in response to the information indicating that the content requesting node and another node are requesting the content.

The network may be a network of infrastructure-based content centric networking (CCN), and the node is a CCN router.

The network may be an adhoc content centric networking (CCN), and the node is a caching node.

The information may include information about a popularity of the content.

The method may also include determining the popularity based on a number of nodes requesting the content from the node in the network.

The node may calculate the number of nodes requesting the content from the node based on a pending interest table (PIT), and each entry on the PIT may include a name of content corresponding to respective entries, a list of at least one face of the node to which the request for the corresponding content is made, and a message authentication code (MAC) key for the request for the corresponding content transmitted via each of the at least one face.

The determining may include determining the content is to be verified in response to a number of nodes requesting the content from the node being greater than a predetermined value, and determining the content is not to be verified in response to the number of nodes requesting the content from the node being less than the predetermined value.

The verifying of the content and transmitting of the content may include performing signature verification of the content, determining whether the content is valid based on the signature verification, generating a message authentication code (MAC) of the content, and transmitting the content and the MAC to the content requesting node.

The generating of the MAC of the content may include generating MACs of the content using MAC keys for the nodes requesting the content, and the transmitting of the content and the MAC to the content requesting node may include transmitting the generated MACs to the content requesting node.

The request for the content may include a name of the content, and a value obtained by encoding an MAC key for the content requesting node through use of a public key of the node.

In accordance with an illustrative example, there is provided a non-transitory computer-readable storage medium comprising a program comprising instructions to cause a computer to perform the method described above.

In accordance with another illustrative example, there is provided a node in a network, including a networking unit configured to receive a request for content from a content requesting node in the network; and a processor configured to determine whether to verify the content based on information, wherein, in response to the processor not verifying the content, the networking unit is configured to transmit the content to the content requesting node, and wherein, in response to the processor verifying the content, the networking unit is configured to transmit the content to the content requesting node.

The processor may determine that the content is not to be verified in response to the information indicating that the content requesting node is an only node requesting the content.

The processor may determine that the content is to be verified in response to the information indicating that the content requesting node and another node are requesting the content.

The information about the content may be related to popularity of the content.

The popularity may be determined based on a number of nodes requesting the content from the node in the network.

The processor may be configured to determine the content is to be verified in response to a number of nodes requesting the content from the node in the network to be greater than a predetermined value, and determine the content is not to be verified in response to the number of nodes requesting the content from the node in the network being less than the predetermined value.

In response to the content being determined to be verified, the processor may be configured to perform signature verification of the content, determine whether the content is valid based on the signature verification, and generate a message authentication code (MAC) for the content, and the networking unit may be configured to transmit the content and the MAC to the content requesting node.

The processor may generate MACs of the content using MAC keys for the nodes requesting the content from the node, and the networking unit may transmit the generated MACs to the content requesting node.

The networking unit may request the content from a source node in the network, and receives the content from the source node.

In accordance with another illustrative example, there is provided a method using content by a node in a network, the method includes determining whether the content is verified in advance; selecting a method to determine whether the content is valid based on a result of the determination, and determining whether the content is valid based on the selected method; and playing the content in response to the content being determined to be valid.

In accordance with an illustrative example, there is provided a non-transitory computer-readable storage medium comprising a program comprising instructions to cause a computer to perform the method described above.

Other features and aspects will be apparent from the following detailed description, the drawings, and the claims.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram illustrating an example of distribution and authentication of content in infrastructure-based content centric networking (CCN), in accordance with an embodiment.

FIG. 2 is a diagram illustrating an example of distribution and authentication of content in an adhoc CCN, in accordance with an embodiment.

FIG. 3 is a diagram illustrating an example of a structure of a node, in accord with an embodiment.

FIG. 4 is a flowchart illustrating an example of a method providing content, in accordance with an embodiment.

FIG. 5 is a flowchart illustrating an example of a method using content, in accordance with an embodiment.

FIG. 6 is a diagram illustrating an example of a method providing content, in accordance with an embodiment.

FIG. 7 is a diagram illustrating an example of a request for content, in accordance with an embodiment.

FIG. 8 is a diagram illustrating an example of a configuration of a pending interest table (PIT), in accordance with an embodiment.

FIG. 9 is a diagram illustrating an example of a message authentication code (MAC) signature and forwarding of content, in accordance with an embodiment.

FIG. 10 is a diagram illustrating an example of a method to generate and use the MAC, in accordance with an embodiment.

FIG. 11 is a diagram illustrating an example providing content via a plurality of intermediate nodes, in accordance with an embodiment.

FIG. 12 is a diagram illustrating an example of a PIT of a router, in accordance with an embodiment.

FIG. 13 is a diagram illustrating an example of a PIT of a fourth router, in accordance with an embodiment.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. Also, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

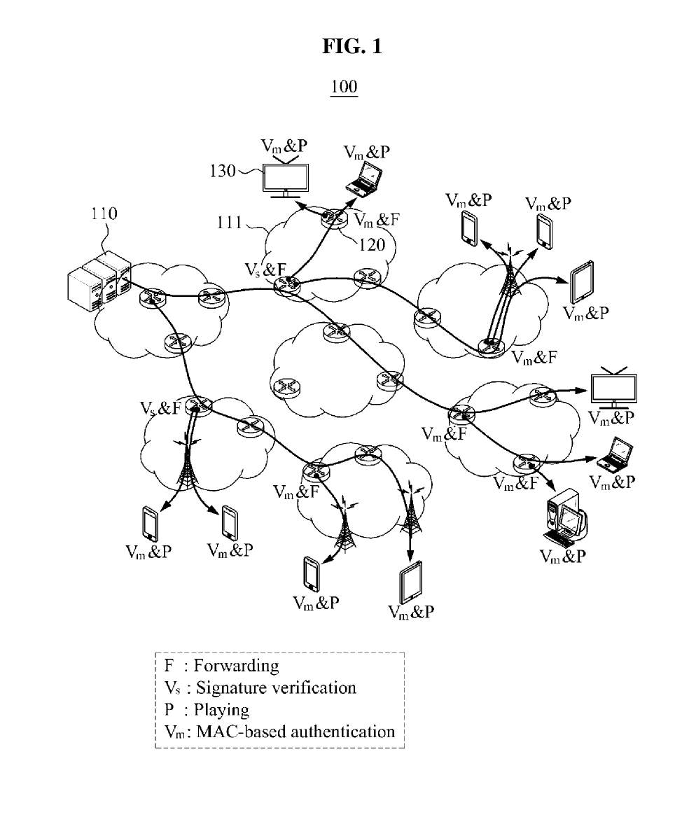

FIG. 1 illustrates an example of distribution and authentication of content in an infrastructure-based content centric networking (CCN) 100, in accordance with an embodiment.

Referring to FIG. 1, the infrastructure-based CCN 100 and a process of distributing content in the infrastructure-based CCN 100 are illustrated.

The infrastructure-based CCN 100 includes a plurality of nodes.

The infrastructure-based CCN 100 includes a generator or, in the alternative, a plurality of generators 110 of content, a CCN router or, in the alternative, a plurality of CCN routers 120, and a requester or, in the alternative, a plurality of requesters 130 of content. In one illustrative example, the CCN router 120 is an edge CCN router.

The nodes in the infrastructure-based CCN 100 are classified as the generator 100 of the content, the CCN router 120, and the requester 130 of the content. In one example, a start node among the nodes in the infrastructure-based CCN 100 is the generator 110 of the content. An intermediate node is the CCN router 120. An end node is the requester 130 of the content.

As the start node, the generator 110 of the content provides the content. For example, the generator 110 of the content may be a social network server, a video server, or a streaming server. Alternatively, the generator 110 of the content may be a server farm that provides services.

The CCN router 120 forwards the content. For example, the CCN router 120 receives the content from the generator 110 of the content or another CCN router. Also, the CCN router 120 transmits or forwards the received content to another CCN router or the requester 130 of the content. The requester 130 of the content may be a terminal or an electronic device that requests or uses the content. For example, the requester 130 of the content may be a computer, a mobile terminal, a smart phone, a tablet, a mobile device, and a smart television.

In one example, when the requester 130 of the content is the mobile terminal, the requester 130 of the content may be operatively connected to the CCN router 120 via a base station. Alternatively, the base station may also be the infrastructure-based CCN 100 or the CCN router 120.

The infrastructure-based CCN 100 includes at least one sub-network 111. The sub-network 111 includes at least one node. Each of the at least one node corresponds to the generator 110 of the content, the CCN router 120, or the requester 130 of the content.

The content is forwarded to the requester 130 of the content from the generator 110 of the content through the CCN router 120. For example, at least two CCN routers 120, through which the content is forwarded to the requester 130, may be provided.

Functions performed by the plurality of nodes are represented as F, Vₛ, P, and Vₘ with respect to the content. F denotes “forwarding” of the content. V, denotes “signature verification”. P denotes “playing”. Vₘ denotes “message authentication code (MAC)-based authentication”.

An MAC refers to a small piece of information to be used for authentication of a message.

As shown in FIG. 1, the CCN router 120 performs the signature verification of the content and the forwarding of the content. Alternatively, the CCN router 120 performs the MAC-based authentication of the content and the forwarding of the content. As another example, the CCN router 120 forwards the content, absent verification of the content. Correspondingly, the CCN router 120 verifies the content through the signature verification of the content and the MAC-based authentication of the content.

Also, the requester 130 of the content performs the MAC-based authentication of the content and plays the content. The requester 130 plays the content by outputting the content and providing the output content to a user of the requester 130.

When the CCN router 120 forwards the content from the generator 110 to the requester 130, and the requester 130 verifies the content, the content is sent to a final destination, for example, the requester 130, although the content may be invalid. Accordingly, a possibility of erroneous content being distributed in the infrastructure-based CCN 100 may increase. Thus, resources, for example, a bandwidth and an operation in the infrastructure-based CCN 100 may be wasted as a whole.

In FIG. 1, the CCN router 120 performs the verification of the content at an early stage. The CCN router 120 determines whether to verify the content based on information about the content. The information about the content may be related to popularity of the content. The popularity is determined based on a number of nodes requesting the content from the CCN router 120.

The CCN router 120 performs the verification of the content having a high popularity, prior to the forwarding of the content. The CCN router 120 verifies the content to determine the validity of the content. The CCN router 120 prevents erroneous content from being distributed, and saves resources of the infrastructure-based CCN 100 as a whole by determining whether to forward the content, subsequent to the validity determination.

The CCN router 120 performs the signature verification of the content with a high popularity. The CCN router 120 determines the validity of the content at an early stage through the signature verification performed prior to the forwarding.

When the content is valid, the CCN router 120 forwards the content and information of the MAC-based authentication to another CCN router or the requester 130 of the content. For example, the content determined to be valid is distributed to the requester 130 using an MAC-based authentication method.

As described above, the MAC-based authentication method enables a determination that the content does not change during transmission and that the content is transmitted from an appropriate CCN router 120.

When the content is determined to be invalid, the CCN router 120 ceases the forwarding or the distribution of the content.

As shown in FIG. 1, in the infrastructure-based CCN 100, the CCN router 120 performs the signature verification of the content at an early stage, and prevents erroneous content from being distributed through the signature verification. When the CCN router 120 performs the signature verification on all of the content, a load applied to the CCN router 120 increases, and the CCN router 120 selectively performs the signature verification of the content. In one illustrative example, the CCN router 120 selectively verifies the signature of the content based on information about the content, for example, information related to popularity of the content.

In one configuration, the CCN router 120 functions as a proxy when multiple content requesters request identical content. The function of the proxy refers to proxy signature verification. By way of example, when the multiple content requesters request identical content, the CCN router 120 performs the signature verification on the content, prior to the multiple content requesters performing the signature verification. The CCN router 120 subsequently transmits the content to the multiple content requesters requesting the content. The CCN router 120 prevents, at an early stage, distribution of erroneous content through the aforementioned signature verification and the transmission.

Also, the multiple content requesters receiving the content perform the MAC-based authentication without performing the signature verification performed by the CCN router 120. Performing the signature verification and transmission at the CCN router 120 assures that the content is not changed during the transmission and that the content is transmitted from the reliable CCN router 120 through the MAC-based authentication to the multiple content requesters. Also, the MAC-based authentication may be performed more rapidly than the signature verification.

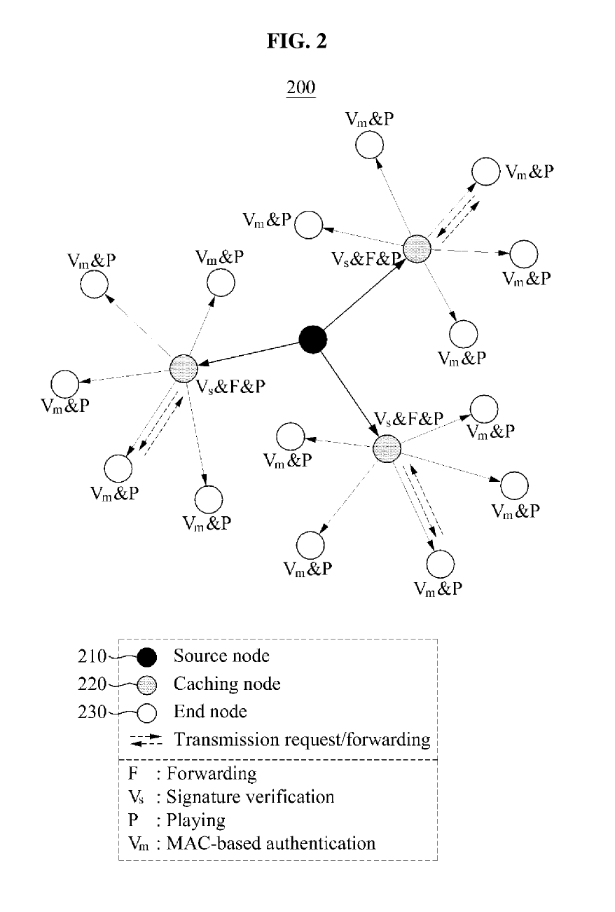

FIG. 2 illustrates an example of distribution and authentication of content in adhoc CCN 200, in accord with an embodiment.

Referring to FIG. 2, the adhoc CCN 200 and a process of distributing content in the adhoc CCN 200 are illustrated. The adhoc CCN 200 is infraless CCN.

The adhoc CCN 200 includes a plurality of nodes. By way of example, the adhoc CCN 200 includes a source node or a plurality of source nodes 210, a caching node or a plurality of caching nodes 220, and an end node or a plurality of end nodes 230. For example, the plurality of nodes in the adhoc CCN 200 is classified into the source node 210, the caching node 220, or the end node 230.

Typically, the plurality of nodes in the adhoc CCN 200 utilizes or plays content, and forwards the content. The caching node 220 corresponds to an intermediate node that forwards the content. Also, each of the plurality of nodes in the adhoc CCN 200 performs verification of the content. However, when all of the plurality of nodes performs the identical signature verification of the identical content, due to an overlap between the signature verification, efficiency of distribution of the content may decrease. Accordingly, as described in the foregoing with reference to FIG. 1, detection of erroneous content and prevention of an excess load due to the overlapping signature verification may be required of the adhoc CCN 200.

In FIG. 2, functions performed by the plurality of nodes are represented as F, Vₛ, P, and Vₘ with reference to the content. F denotes “forwarding” of the content, Vₛ denotes “signature verification”, P denotes “playing”, and Vₘ denotes “MAC-based authentication”.

As shown in FIG. 2, the caching node 220 performs the signature verification of the content, the forwarding of the content, and the playing of the content. The end node 230 performs the MAC-based authentication of the content and the playing of the content. For example, the catching node 220 performs the signature verification of the content and, subsequent to validity being verified through the signature verification, performs the MAC-based authentication of the content. In another example, the caching node 220 generates a MAC of the content with respect to the content of which the validity is verified through the signature verification, and transmits the generated MAC along with the content. The caching node 220 generates the MAC of the content using a key shared by neighboring nodes.

Another caching node or the end node 230 receives the content and the MAC from the caching node 220. Through use of an MAC value of the content, the caching node 220 assures the nodes that receive the content and the MAC that the content is determined to be valid, and that the content has not changed during the transmission.

As shown in FIG. 2, in the adhoc CCN 200, the caching node 220 performs the signature verification of the content at an early stage, and prevents erroneous content from being distributed through the signature verification.

In one illustrative configuration, when the caching node 220 performs the signature verification on all of the content, a load applied to the caching node 220 increases. To resolve a potential overload, the caching node 220 may selectively perform the signature verification of the content based on information about the content. The information may be related to popularity of the content.

For one example, the caching node 220 functions as a proxy when other caching nodes and end nodes request the identical content. In another example, when the other caching nodes and end nodes request the identical content, the caching node 220 performs the signature verification of the content, and transmits the content to the other caching nodes and end nodes requesting the content. The caching node 220 prevents distribution of erroneous content in an early stage through the aforementioned signature verification and the transmission.

Also, each of the multiple other caching nodes and end nodes receiving the content performs the MAC-based authentication without performing the signature verification as performed by the caching node 220. The other caching nodes and end nodes are assured that the content is not changed during the transmission and that the content is transmitted from the reliable caching node 220 through the MAC-based authentication.

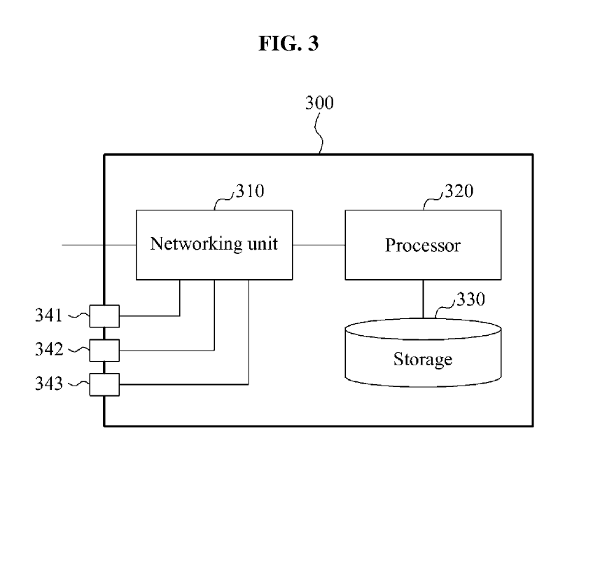

FIG. 3 illustrates an example of a structure of a node 300, in accord with an embodiment.

The node 300 may be an intermediate node or an end node in a network. The network may be a wired network or a wireless network. The network includes at least one sub-network. Each of the at least one sub-network may be a wired network or a wireless network.

The node 300 includes a networking unit 310, a processor 320, and a storage 330.

The networking unit 310 may be a hardware module, for example, a network interface card, a network interface chip, a network interface port, a network device driver, or other modules known to one of ordinary skill in the art.

The processor 320 is at least one processor or at least one core in a processor. The processor 320 executes functional operations of the node 300. The storage 330 stores data including data required for the functional operation of the node 300. For example, the storage 330 stores a pending interest table (PIT) which is to be described later.

The processor 320 and the networking unit 310 provide at least one face or interface. In FIG. 3, a first face “face1” 341, a second face “face2” 342, and a third face “face3” 343 are depicted as the at least one face.

The at least one face may be an interface that provides networking with the node 300. Alternatively, the at least one face may be a physically distinguishable interface, such as a port, or a logically distinguishable interface, such as a number of a socket. The at least one face may be an identifier that indicates concatenation to a predetermined node in the network.

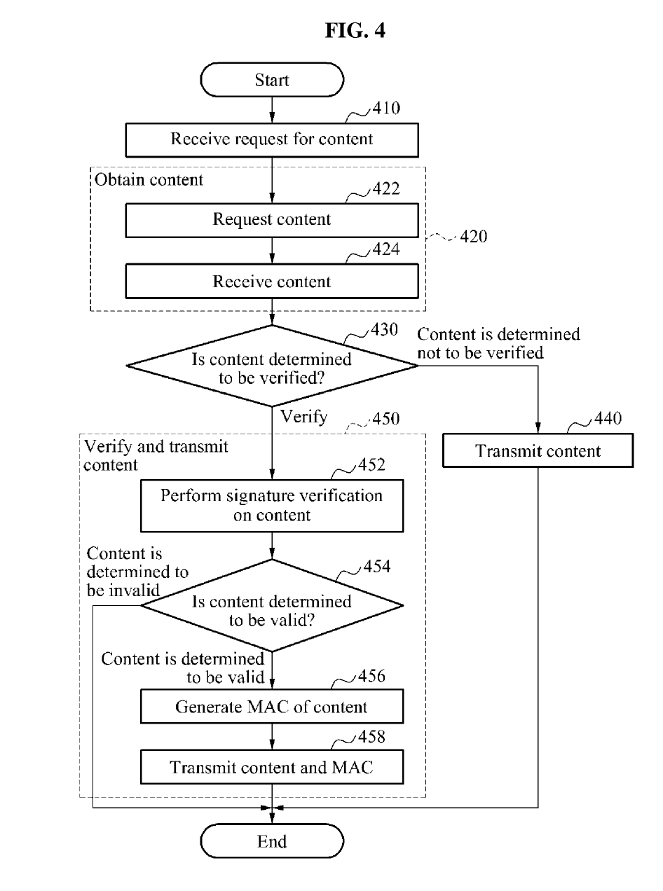

FIG. 4 illustrates an example of a method providing content, in accordance with an embodiment.

The node 300 in a network provides content. The method to provide the content is performed at the node 300 in the network. The network may be the infrastructure-based CCN 100 described in the preceding with reference to FIG. 1, or the adhoc CCN 200 described in the preceding with reference to FIG. 2.

The node 300 may be an intermediate node in the network. For instance, the node 300 may be the CCN router 120 described in the foregoing with reference to FIG. 1, or the caching node 220 described in the foregoing with reference to FIG. 2.

At operation 410, the method providing content at the networking unit 310 of the node 300 receives a request for the content from a first node in the network. The first node is a content requesting node requesting the content. The first node may be the requester 130 of the content described in the foregoing with reference to FIG. 1, or the end node 230 described in the foregoing with reference to FIG. 2.

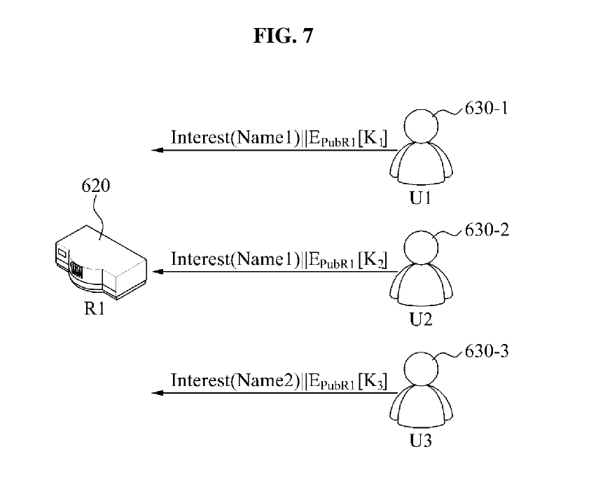

The request for the content and data included in the request for the content will be discussed later with reference to FIG. 7.

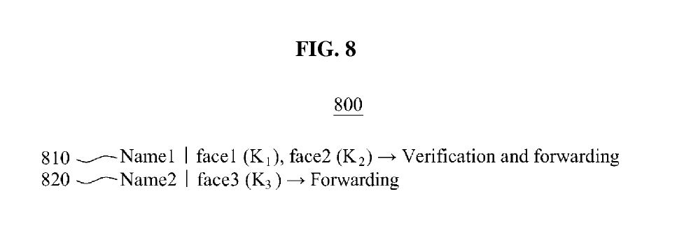

The processor 320 configures a PIT based on the received request for the content, in response to receiving the request for the content. A method to configure the PIT will be discussed later with reference to FIG. 8.

At operation 420, the method at the node 300 obtains the requested content. When the node 300 obtains or stores the requested content in advance, operation 420 may be omitted.

Operation 420 includes operations 422 and 424.

At operation 422, the method requests at the processor 320 of the node 300 the content from a second node through the networking unit 310. The method at networking unit 310 transmits the request for the content to the second node. The second node may be the generator 110 of the content described in the preceding with reference to FIG. 1, or the source node 210 described in the preceding with reference to FIG. 2.

At operation 424, the method receives at the networking unit 310 the content from the second node.

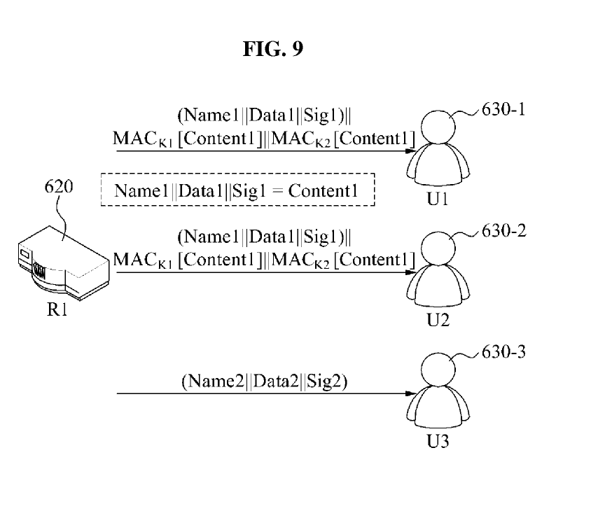

A configuration of the received content will be discussed later with reference to FIG. 9.

At operation 430, the method at the processor 320 determines whether to verify the content based on information about the content.

The information about the content may be related to popularity of the content. The method at the processor 320 determines the popularity of the content based on a number of nodes requesting the content from the node 300 in the network. The nodes requesting the content include the first node.

For example, at operation 430, the method at the processor 320 determines that the content is not to be verified when a node requesting the content from the node 300 in the network is only the first node. When a single node, for example, the first node, requests the content, the method directly performs content verification at the first node requesting the content to reduce a load throughout the network. However, the method at the processor 320 determines that the content is to be verified when at least two nodes request the content from the node 300 in the network. When the at least two nodes request the content, the method at the node 300 performs content verification at an early stage to reduce a load throughout the network.

Alternatively, at operation 430, the method at the processor 320 determines that the content is to be verified when the number of nodes requesting the content from the node 300 in the network is greater than a predetermined value, and determines that the content is not to be verified when the number of nodes requesting the content from the node 300 in the network is less than the predetermined value.

The method at the processor 320 determines the number of nodes requesting the content from the node 300 in the network based on the PIT. A method to determine the number of nodes requesting the content from the node 300 in the network based on the PIT will be discussed later with reference to FIG. 8.

At operation 440, when the content is determined not to be verified, the method at the networking unit 310 transmits the content to the first node.

For example, the method at the node 300 forwards the content received from the second node to the first node without performing the verification of the content.

When the content is determined to be verified, the method at the processor 320 verifies the content, and the method from the networking unit 310 transmits the content to the first node in 450.

Operation 450 includes operations 452, 454, 456, and 458.

At operation 452, the method at using the processor 320 of FIG. 3 performs the signature verification of the content.

A method performing the signature verification of the content by the processor 320 will be discussed later with reference to FIG. 9.

At operation 454, the method at the processor 320 determines whether the content is valid based on the signature verification of the content. When method using the processor 320 determines the content to be valid, 456 is performed. When the method using the processor 320 determines the content to be invalid, the process may be completed.

A method determining whether the content is valid will be discussed later with reference to FIG. 9.

At operation 456, the method at the processor 320 generates an MAC of the content with reference to the content.

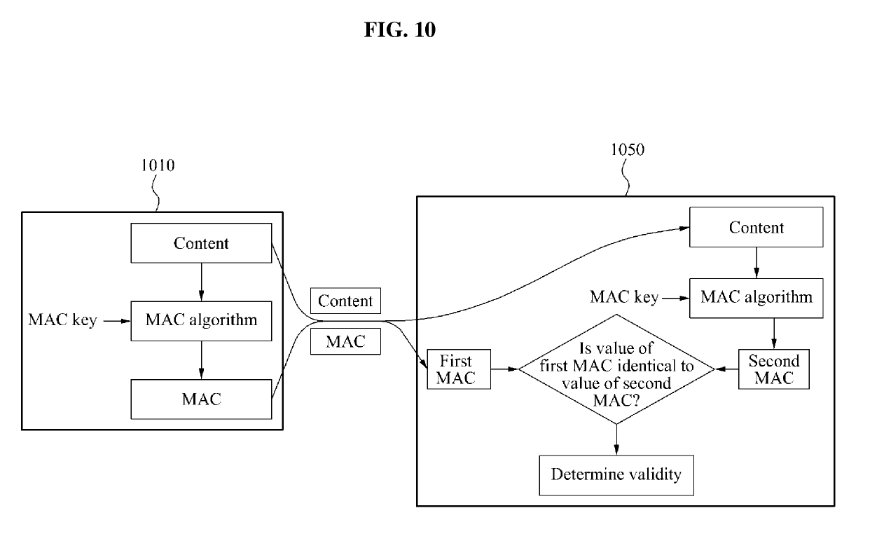

A method generating the MAC of the content will be discussed later with reference to FIG. 10.

At operation 458, the method at the networking unit 310 transmits the content and the generated MAC to the first node. For example, the method at the networking unit 310 transmits the content along with the generated MAC to the first node.

The MAC transmitted along with the content will be discussed later with reference to FIG. 9.

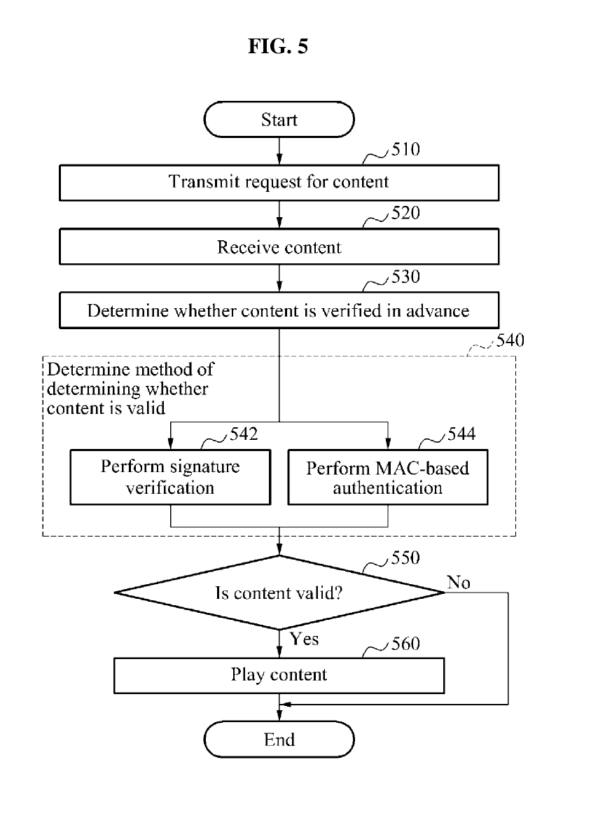

FIG. 5 illustrates an example of a method using content, in accord with an embodiment.

The first node described in the preceding with reference to FIG. 4 requests and plays content. In one illustrative configuration, the node 300 described in FIG. 3 performs functions of the intermediate node of FIG. 4 and works in conjunction with the operations of the first node of FIG. 5.

The first node includes a networking unit and a processor. The networking unit of the first node may correspond to the networking unit 310 of the node 300. The processor of the first node may correspond to the processor 320 of the node 300.

At operation 510, the method at the networking unit of the first node transmits a request for content to the node 300 in the network. For example, the request for the content may correspond to the request for the content at operation 410 of FIG. 4.

At operation 520, the method at the networking unit of the first node receives the content from the node 300. Operation 520 may correspond to operations 440 and 458 described in the preceding with reference to FIG. 4.

At operation 530, the method at the processor of the first node determines whether the content received from the node 300 is verified in advance, based on the received content.

For example, when the content includes a MAC, the method at the processor of the first node determines that the content is verified in advance by the node 300. When the content does not include the MAC, the method at the processor of the first node determines that the content is not verified in advance by the node 300.

At operation 540, the method at the processor of the first node selects one of a plurality of methods that determines whether the content is valid based on a result of the determination, and determines whether the content is valid based on the selected method.

Operation 540 includes operations 542 and 544.

When method at the processor of the first node determines the content is verified in advance by the node 300, at operation 542, the method at the processor of the first node performs MAC-based authentication through use of the MAC.

The method at the processor of the first node determines whether the received content is valid based on a result of the MAC-based authentication.

A method to perform the MAC-based authentication and to determine whether the content is valid will be discussed later with reference to FIG. 10.

When the method at the processor of the first node determines that the content is not verified in advance by the node 300, at operation 544, the method at the processor of the first node performs the signature verification.

At operation 544, the method at the processor of the first node determines whether the received content is valid based on a result of the signature verification.

A method to perform the signature verification and to determine whether the content is valid will be discussed later with reference to FIG. 9.

At operation 550, the method determines whether the content is valid. In response to the content being valid, at operation 560, the method at the first node plays the content. In response to the content not being valid, the method ends.

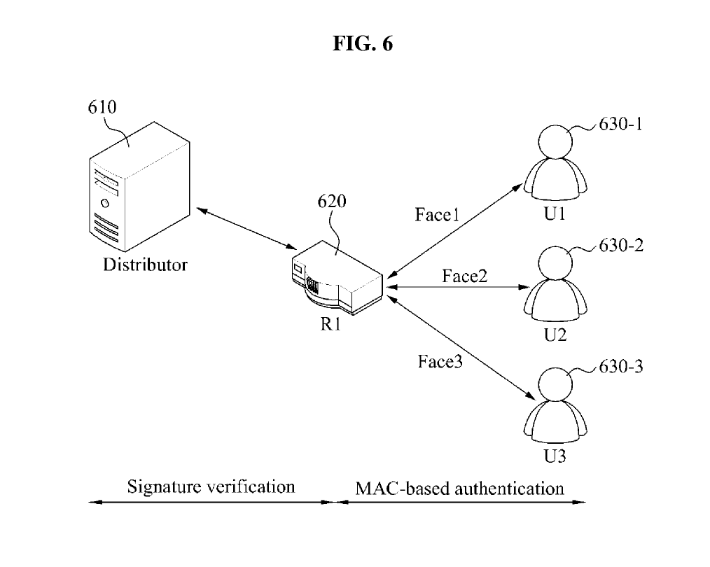

FIG. 6 illustrates an example of a method providing content, in accordance with an embodiment.

For the examples provided with reference to FIGS. 4 and 5 to operate, in one illustrative configuration, 18 the following conditions may be required.

In the infrastructure-based CCN 100, nodes requesting content may be aware in advance of information about the CCN router 120 to which the nodes requesting the content are concatenated. For example, the information includes information about the CCN router 120 concatenated to at least one face of the requester 130, a public key of the CCN router 120, and reliability of the CCN router 120.

Also, the CCN router 120 may be aware in advance of information about other CCN routers to which the CCN router 120 is concatenated.

2. In the adhoc CCN 200, end nodes may be aware in advance of information about the caching node 220 to which the end nodes are concatenated. For example, the information includes information about the caching node 220 concatenated to at least one face of the end node 230, a public key of the caching node 220, and reliability of the caching node 220.

Also, the caching node 220 may be aware in advance of information about other caching nodes to which the caching node 220 is concatenated.

In FIG. 6, a single distributor 610, a single router 620, and at least one user are concatenated. A first user 630-1, a second user 630-2, and a third user 630-3 are depicted as the at least one user. In FIG. 6, the router 620 is depicted as “R1”, and the at least one user is depicted as “U1, U2, and U3”.

For example, the distributor 610 may correspond to the second node described in the foregoing with reference to FIG. 4. The router 620 may correspond to the node 300 described in the foregoing with reference to FIG. 4. The at least one user may correspond to the first node described in the foregoing with reference to FIG. 4.

The distributor 610 and the router 620 communicate with one another. The router 620 and the at least one user communicate with each other via a face. The first user 630-1, the second user 630-2, and the third user 630-3 are concatenated to the router 620 via “face1”, “face2”, and “face3”, respectively.

As shown in FIG. 6, signature verification may be performed in a relationship between the distributor 610 and the router 620, and MAC-based authentication may be performed in a relationship between the router 620 and the at least one user.

FIG. 7 illustrates an example of a request for content, in accordance with an embodiment.

Referring to FIG. 7, each of at least one user requests content from the router 620.

In FIG. 7, “Interest” indicates the request for the content.

“Name1” indicates a name of first content requested by the first user 630-1 and the second user 630-2. “Name2” indicates a name of second content requested by the third user 630-3.

“K₁”, “K₂”, and “K₃” are MAC keys to be used in an MAC subsequently. “K₁” is an MAC key to be used for a MAC by the first user 630-1. “K₂” is an MAC key to be used for a MAC by the second user 630-2. “K₃” is a MAC key to be used for a MAC by the third user 630-3.

Eₓ denotes encoding through use of an “x” key. E_{PubR1} denotes encoding through use of a public key “PubR1” of the router 620. E_{PubR1}(K₁) denotes a value obtained by encoding the MAC key “K₁” of the first user 630-1 using the public key “PubR1” of the router 620. E_{PubR1}(K₂) denotes a value obtained by encoding the MAC key “K₂” of the second user 630-2 using the public key “PubR1” of the router 620. E_{PubR1}(K₃) denotes a value obtained by encoding the MAC key “K₃” of the third user 630-3 using the public key “PubR1” of the router 620. Each of the at least one user may be, in advance, aware of the public key of the router 620.

“∥” denotes concatenating. For example, “∥” indicates that an object represented in front of “∥” is continuously transmitted together with an object represented behind “∥”.

Referring to FIG. 7, the following descriptions are applied to the method described with respect to FIG. 4.

The request for the content described at operation 410 with reference to FIG. 4 includes 1) a name of the content and 2) a value obtained by encoding a MAC key of the first node using a public key of the node 300.

The first node concatenated to the node 300 may be aware in advance of the public key of the node 300, prior to the request for the content. Alternatively, prior to the request for the content, the first node requests the public key from the node 300 and receives the public key from the node 300.

In response to the content being requested, the node 300 obtains the first content “Name1” and the second content “Name2” in 420 described in the preceding with reference to FIG. 4.

FIG. 8 illustrates an example of a configuration of a PIT 800, in accord with an embodiment.

The processor 320 of the node 300 manages the PIT 800. The storage 330 stores the PIT 800.

The PIT 800 includes at least one entry. With respect to content for which a request is made to the node 300, the at least one entry is generated to correspond to each of the content.

The at least one entry includes a name of the content corresponding to each entry, a list of at least one face of the node 300 to which the request for the corresponding content is made, and a MAC key for the request for the corresponding content transmitted via each of the at least one face.

In FIG. 8, the PIT 800 indicates a result in which the node 300 receives requests for the content transmitted in FIG. 7.

In FIG. 8, a first entry 810 includes a name “Name1” of first content corresponding to the first entry 810. Also, the first entry 810 includes “face1” and “face2”, as the list of the at least one face or interface to which the request for the first content is made. Also, the first entry 810 includes the MAC key “K₁” for the request for the content transmitted via “face1”, and the MAC key “K₂” for the request for the content transmitted via “face2”. The first entry 810 indicates that the first user 630-1 and the second user 630-2 request the identical content “Name1”. The MAC keys “K₁” and “K₂” may be used for subsequent MAC authentication.

A second entry 820 includes a name “Name2” of second content corresponding to the second entry 820. Also, the second entry 820 includes “face3” as the list of the at least one face to which the request for the second content is made. Also, the second entry 820 indicates that the third user 630-3 requests the content “Name2”. The MAC key “K₃” may be used for subsequent MAC authentication.

As described in operation 410 of FIG. 4, in response to receiving of the request for the content, the processor 320 of the node 300 configures the PIT 800 based on the received request for the content.

When an entry of the requested content is absent from among the at least one entry of the PIT 800, the processor 320 generates the entry corresponding to the requested content, and adds the generated entry to the at least one entry of the PIT 800. The processor 320 adds a name of the requested content to the generated entry.

The processor 320 adds a face to which the request for the content is transmitted to the list of the at least one face. Also, the processor 320 adds a MAC key included in the request for the content to the entry corresponding to the content.

The processor 320 determines the name of the requested content, the face from which the content is requested, and the MAC key included in the request for the content by analyzing information about the request for the content, based on the configurations described in the examples thus far. Also, the processor 320 determines a list of the requested content. The processor 320 determines a number of faces or nodes requesting the content with respect to the requested content.

Further, the processor 320 determines another node to which each of the at least one face is concatenated, with respect to each of the at least one face. Accordingly, in the descriptions provided in the preceding, the face stored in the PIT 800 may be substituted for by another node concatenated to the node 300.

As described in operation 430 of FIG. 4, the processor 320 determines the number of nodes requesting the content from the node 300 in the network, based on the PIT 800.

Based on the list of the at least one face, the processor 320 selects the entry corresponding to the content requested from the at least one entry, and determines the number of nodes or faces requesting the requested content.

For example, at operation 430, when the name of the requested content is “Name1”, the processor 320 determines the content “Name1” to be popular public content, and determines the content “Name1” to be verified because the content “Name1” is recorded to be requested by two faces within the entry of the PIT 800.

Conversely, when the name of the requested content is “Name2”, the content “Name2” determines the content “Name1” to be unpopular private content, and determines the content “Name2” not to be verified because the content “Name2” is recorded to be requested by a single face within the entry of the PIT 800.

FIG. 9 illustrates an example of a MAC signature and forwarding of content, in accordance with an embodiment.

Referring FIG. 9, the router 620 transmits content to at least one user.

For example, the router 620 transmits, to the first user 630-1 and the second user 630-2, a name “Name1” of first content, data “Data1” of the first content, a signature “Sig1” of the first content, a MAC value “MAC_{K1}[content1]” of the first content generated through use of an MAC key “K₁”, and a MAC value “MAC_{K2}[content1]” of the first content generated through use of an MAC key “K₂”.

A method to generate an MAC value will be described later with reference to FIG. 10.

Also, the router 620 transmits, to the third user 630-3, a name “Name2” of second content, data “Data2” of the second content, and a signature “Sig2” of the second content.

In operation 424 of FIG. 4, the received content includes a name of the content, data of the content, and a signature of the content.

The signature of the content refers to a value obtained by encoding the name of the content and the data of the content, through use of a secret key of the second node.

For example, the signature of the content is represented by Equation 1.

Sig=Sign(Name∥Data) [Equation 1]

where “Sig1” denotes the signature of the content. “Sign” denotes an encoding function based on the secret key of the second node. “Name” denotes the name of the content. “Data” denotes the data of the content.

Also, sizes of “Name” and “Data” may be too substantial to be encoded. Accordingly, a hash or a hash function may be used for the signature of the content as expressed by Equation 2.

Sig=Sign(H(Name∥Data) [Equation 2]

where “H” denotes the hash function. For example, the second node generates the name of the content and hash values of the data of the content, and generates the signature by encoding the hash value through use of the secret key of the second node.

As described in operation 454 of FIG. 4, the processor 320 performs the signature verification of the content using the name of the content, the data of the content, and the signature of the content.

The processor 320 generates a verification value of the content based on a public key of the second node and the signature of the content.

For example, the verification value of the content is derived from Equation 3.

Result=Verify(Sig) [Equation 3]

In Equation 3, “Result” denotes the verification value of the content. “Verify” denotes a decoding function based on the public key of the second node. The aforementioned “Sign” and “Verify” may correspond to each other. For example, when an input value is encoded by “Sign” and decoded by “Verify”, a value output subsequent to the encoding and the decoding being performed may be identical to the input value.

The processor 320 determines whether the content is valid by comparing the verification value and the signature.

As described in operation 454 of FIG. 4, the processor 320 determines whether the content is valid based on the verification value of the content and the signature of the content.

The processor 320 determines the content to be valid when the verification value of the content is identical to the signature of the content. In contrast, the processor 320 determines that the content is invalid when the verification value of the content is not identical to the signature of the content.

The signature of the content is “Sign(Name∥Data)” when the signature is generated by Equation 1. Alternatively, when the signature is generated by Equation 2, the signature of the content is “Sign(H(Name∥Data))”.

Referring to FIG. 9, the processor 320 performs signature verification of the content with respect to the first content “Name1”, and determines whether the content transmitted to the node 300 is valid. Subsequently, the node 300 transmits the content to a first terminal requesting the first content “Name1”, for example, the first user 630-1 and the second user 630-2.

As described in operation 456 of FIG. 4, the processor 320 generates a MAC of the content to securely transmit the content to the first terminal.

The processor 320 generates MACs of the content through use of “K₁” transmitted from the first user 630-1 and “K₂” transmitted from the second user 630-2.

As described in operation 456 of FIG. 4, the processor 320 generates MACs of the content through use of a plurality of MAC keys of nodes requesting the content from the node 300.

Also, as described in operation 458 of FIG. 4, the networking unit 310 transmits the content and the MACs generated through use of the plurality of MAC keys.

For example, a number of the MACs transmitted may be at least one. The at least one MAC may correspond to the plurality of MAC keys of the nodes requesting the content. The first node receives an MAC generated by an MAC key of the first node, and a MAC generated by MAC keys of other nodes requesting the content from the node 300.

Identical messages or data may be transmitted to the nodes requesting the content from the node 300 including the first terminal. The networking unit 310 transmits to the first node the content and the MACs generated by the plurality of MAC keys via multicast or broadcast.

Referring to FIG. 9, the first node that receives the content detects MACs transmitted along with the content, and determines that the content is determined, in advance, to be valid through the signature verification. Also, the first node learns that no change has occurred in the content during the transmission of the content.

The processor 320 also determines whether the content includes the signature of the content. For example, the processor 320 includes or excludes the signature of the content to be transmitted to the first node. The first node determines whether the content is valid using the MAC of the content and including or excluding the signature of the content.

When the signature is determined not to be included, a length of the content to be transmitted may decrease. However, a node may not verify the validity of the content when the content does not include a MAC key corresponding to the MAC.

When the signature is determined to be included, the length of the content to be transmitted may increase. However, a node may verify the validity of the content through the signature verification when the content does not include the MAC key corresponding to the MAC of the content.

The processor 320 determines whether the content includes the signature of the content based on the request of the first node. Whether the content includes the signature of the content is based on whether the first node intends to redistribute the content subsequent to reception.

In one example, when the first node is configured to likely redistribute the content later, the processor 320 includes the signature of the content in the content. Conversely, when the first node simply plays the content, the processor 320 may remove the signature from the content.

In another example, when the first node indicates that the signature is to be included in the content and transmits the content to the node 300, the processor 320 includes the signature in the content.

By way of example, absent the MAC key, the first node redistributes the content and the node performs the signature verification of the content. Accordingly, the processor 320 includes the signature in the content by default for smooth distribution of the content. Consequently, when the first node possesses an MAC key to verify a MAC, the first node performs MAC-based authentication. When the first node does not possess the MAC key, the first node performs the signature verification.

As described in the foregoing with reference to FIG. 5, the processor of the first node may also perform the signature verification of the content.

As described in operation 542 in the preceding with reference to FIG. 5, the processor of the first node performs the signature verification of the content using the name of the content, the data of the content, and the signature of the content.

The processor of the first node generates a verification value of the content based on the public key of the second node and the signature of the content. For example, the verification value of the content is given by Equation 3.

The processor of the first node determines whether the content is valid by comparing the verification value and the signature.

Also, the processor of the first node determines whether the content is valid based on the verification value of the content and the signature of the content.

The processor of the first node determines the content to be valid when the verification value of the content is identical to the signature of the content. However, when the verification value of the content is not identical to the signature of the content, the processor of the first node determines the content to be invalid.

The signature of the content is “Sign(Name∥Data)” when the signature is generated by Equation 1. Alternatively, when the signature is generated by Equation 2, the signature of the content is “Sign(H(Name∥Data))”.

FIG. 10 illustrates an example of a method generating and using a MAC, in accordance with an embodiment.

Referring to FIG. 10, a sender 1010 and a receiver 1050 are illustrated.

The sender 1010 and the receiver 1050 may correspond to the node 300 and the first node previously described, respectively.

The processor 320 of the node 300 uses content and a MAC key as an input of an MAC algorithm. The processor 320 generates a MAC of the content by performing the MAC algorithm to which the content and the MAC key are input.

The MAC key may be a secret key managed by the first node, or may be transmitted to the node 300 from the first node to generate a MAC.

As previously described with reference to FIG. 7, the request for the content includes a name of the content and a value obtained by encoding the MAC key of the first node using a public key of the node 300. The processor 320 of the node 300 obtains the MAC key of the first node by decoding the value obtained by encoding the MAC key of the first node using the secret key of the node 300.

The MAC algorithm outputs the MAC.

The networking unit 310 of the node 300 transmits the content and the MAC to the first node. The networking unit of the first node receives the content and the MAC from the node 300.

Hereinafter, the MAC transmitted to the first node is referred to as a first MAC.

The processor of the first node generates a second MAC through use of the MAC key. The MAC key may be used for MAC authentication by the first node.

The processor of the first node uses the content and the MAC key as an input of an MAC algorithm. The processor of the first node generates the second MAC of the content by executing the MAC algorithm to which the content and the MAC key are input.

The processor of the first node determines validity of the transmitted content by comparing the first MAC with the second MAC.

The processor of the first node determines the content to be valid when a value of the first MAC is identical to a value of the second MAC. When the value of the first MAC is not identical to the value of the second MAC, the processor of the first node determines the content to be invalid.

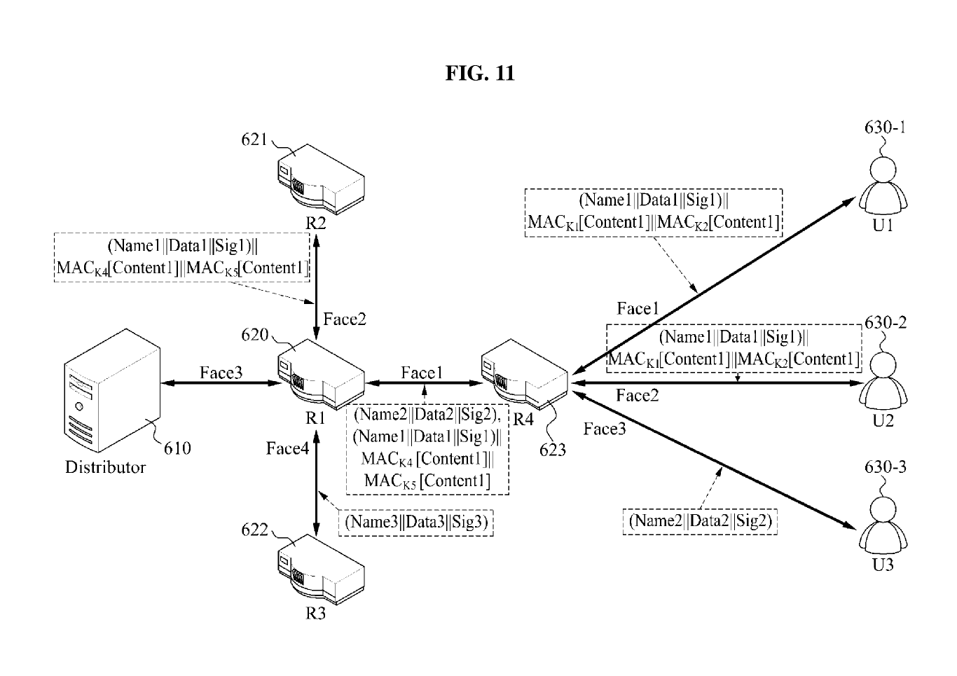

FIG. 11 illustrates an example providing content via a plurality of intermediate nodes.

Referring to FIG. 11, routers are additionally concatenated. A second router 621, a third router 622, and a fourth router 623 are illustrated. The second router 621, the third router 622, and the fourth router 623 correspond to the node 300 previously described with reference to FIG. 3.

In FIG. 11, the second router 621, the third router 622, and the fourth router 623 are represented as “R2”, “R3”, and “R4”, respectively.

The router 620 is concatenated to the distributor 610 via “Face3”.

The router 620 is concatenated to the fourth router 623 via “Face1”, concatenated to the second router 621 via “Face2”, and concatenated to the third router 622 via “Face4”.

The fourth router 623 is concatenated to the router 620. Also, the fourth router 623 is concatenated to the first user 630-1 via “Face1”, concatenated to the second user 630-2 via “Face2”, and concatenated to the third user 630-2 via “Face 3”.

The second router 621 requests the first content from the router 620 via “Face2” of the router 620. Also, the fourth router 623 requests the first content from the router 620 via “Face1” of the router 620. The first content is requested via at least two faces. For example, at least two nodes in the network request the first content from the node 300. Accordingly, the router 620 transmits the first content and MACs of the first content to the second router 621 and the fourth router 623, subsequent to performing verification. For example, a plurality of MACs of the first content may be provided. The plurality of MACs of the first content includes an MAC “MAC_{K4}[Content]” generated through use of the first content and an MAC key “K4” of the fourth router 623, and an MAC “MAC_{K5}[Content]” generated through of the first content and an MAC key “K5” of the second router 621.

The first content includes “Name1”, “Data1”, and “Sig1”. “Name1”, “Data1”, and “Sig1” represent a name of the first content, data of the first content, and a signature of the first content, respectively.

The fourth router 623 requests second content from the router 620 through “Face1” of the router 620. The second content is requested through a single face. For example, a single node in a network requests the second content from the node 300. Accordingly, the router 620 transmits the second content to the fourth router 623, without performing the verification in an early stage. The second content includes “Name2”, “Data2”, and “Sig2”. “Name2”, “Data2”, and “Sig2” represent a name of the second content, data of the second content, and a signature of the second content, respectively.

The third router 622 requests third content from the router 620 through “Face4” of the router 620. The third content is requested via a single face. For example, a single node in a network requests the third content from the node 300. Accordingly, the router 620 transmits the third content from the third router 622 without performing the verification at an early stage. The third content includes “Name3”, “Data3”, and “Sig3”. “Name3”, “Data3”, and “Sig3” represent a name of the third content, data of the third content, and a signature of the third content, respectively.

As described above, the fourth router 623 that receives the first content and the second content transmits the received first content and the second content to users.

The first user 630-1 requests the first content from the fourth router 623 via “face1” of the fourth router 623. Also, the second router 630-2 requests the first content from the fourth router 623 through “Face2” of the fourth router 623. The first content is requested through at least two faces. For example, at least two nodes in a network request the first content from the node 300.

The fourth router 623 forwards the first content transmitted from the router 620 and the MACs of the first content to the first user 630-1 and the second user 630-2.

Alternatively, the fourth router 623 performs the verification of the first content transmitted from the router 620 in an early stage, and omits the early stage verification of the first content.

The fourth router 623 transmits the first content and the MACs of the first content to the first user 630-1 and the second user 630-2. The plurality of MACs of the first content are provided and include the MAC “MAC_{K1}[Content]” generated using the first content of the first user 630-1 and the MAC key “K₁”, and includes the MAC “MAC_{K2}[Content]” generated using the first content and the MAC key “K₂” of the second user 630-2.

The third user 630-3 requests the second content from the fourth router 623 via the “Face3” of the fourth router 623. The second content is requested via a single face. For example, a single node in a network requests the second content from the node 300. Accordingly, the fourth router 623 transmits the second content to the third user 630-3, without performing the verification at an early stage.

The processing between the node 300 and the first node described in FIG. 4 may be applied to a plurality of intermediate nodes in a network. Each of the plurality of intermediate nodes may be the node 300. For example, each of the first node and the second node as previously described corresponds to the node 300.

Nodes in a network may, in advance, determine public keys of other nodes to which the nodes are concatenated. For example, the nodes include the node 300, the first node, and the second node. Exchanging of the public keys amongst the nodes may be performed concurrently with each of the operations 410, 422, 424, 440, 458, 510, and 520 previously described. Also, the exchanging of the public keys amongst the nodes may be performed during a process in which each node establishes a routing table. As used herein, the routing table refers to a forwarding information table (FIT).

For example, when a network including the node 300 is the adhoc CCN 200, information may be easily shared amongst nodes disposed at a distance of “1” hop from among at least one node in the network. Accordingly, the nodes disposed at the “1” hop distance recognize the public keys of one another. Furthermore, MAC keys may be shared amongst the nodes.

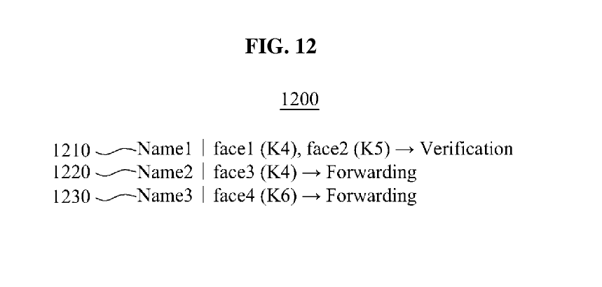

FIG. 12 illustrates an example of a PIT 1200 of a router, in accordance with an embodiment.

Referring to FIG. 12, the PIT 1200 represents the result in which the router 620 receives the requests for the content in FIG. 11.

A first entry 1210 includes a name “Name1” of the first content corresponding to the first entry 1210. Also, the first entry 1210 includes “Face1” and “Face2” as a list of faces from which the first content is requested. Further, the first entry 1210 includes an MAC key “K₄” for a request for content transmitted via “Face1”, and an MAC key “K₅” for a request for content transmitted via “Face2”. The first entry 1210 represents that the second router 621 and the fourth router 623 request the identical first content “Name1”. The MAC keys “K₄” and “K₅” may be subsequently used for MAC authentication.

A second entry 1220 includes a name “Name2” of the second content corresponding to the second entry 1220. Also, the second entry 1220 includes “Face3” as a list of faces from which the second content is requested. Further, the second entry 1220 includes the MAC key “K₄” for a request for content transmitted through “Face3”. The second entry 1220 represents that the fourth router 623 requests the second content “Name2”. The MAC key “K₄” may be used for MAC authentication subsequently.

A third entry 1230 includes a name “Name3” of the third content corresponding to the third entry 1230. Also, the third entry 1230 includes “Face4” as a list of faces from which the third content is requested. Further, the third entry 1230 includes a MAC key “K₆” for a request for content transmitted through “Face4”. The third entry 1230 represents that the third router 622 requests the third content “Name3”. The MAC key “K₄” may be used for MAC authentication subsequently.

The router 620 determines verification of the first content “Name1” requested by at least two nodes. The router 620 determines forwarding of the second content “Name2” and the third content “Name3” requested by a single node.

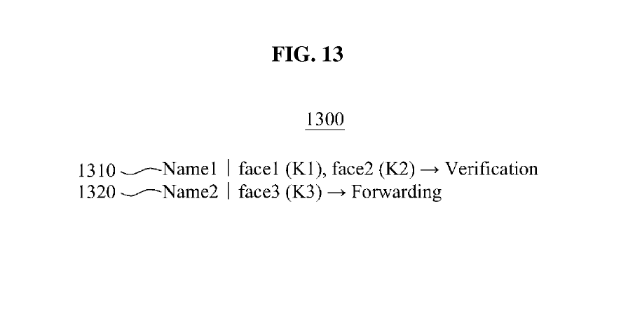

FIG. 13 illustrates an example of a PIT 1300 of a fourth router, in accord with an embodiment.

Referring to FIG. 13, the PIT 1300 represents a result of the fourth router 623 receiving the requests for the content in FIG. 11.

A first entry 1310 includes a name “Name1” of the first content corresponding to the first entry 1310. Also, the first entry 1310 includes “Face1” and “Face2” as a list of faces from which the first content is requested. Further, the first entry 1310 includes an MAC key “K₁” for a request for content transmitted through “Face1”, and an MAC key “K₂” for a request for content transmitted through “Face2”. The first entry 1310 represents that the first user 630-1 and the second user 630-2 request the identical first content “Name1”. The MAC keys “K₁” and “K₂” may be subsequently used for MAC authentication.

A second entry 1320 includes a name “Name2” of the second content corresponding to the second entry 1320. Also, the second entry 1320 includes “Face3” as a list of faces from which the second content is requested. Further, the second entry 1320 includes an MAC key “K₃” for a request for content transmitted through “Face3”. The second entry 1320 represents that the third user 630-3 requests the second content “Name2”. The MAC key “K₃” may be subsequently used for MAC authentication.

The fourth router 623 determines verification of the first content “Name1” requested by at least two nodes. The fourth router 623 determines forwarding of the second content “Name2” requested by a single node.

The units described herein may be implemented using hardware components and software components. For example, the hardware components may include controllers, microphones, amplifiers, band-pass filters, audio to digital convertors, and processors. A processor may be implemented using one or more general-purpose or special purpose computers, such as, for example, a controller and an arithmetic logic unit, a digital signal processor, a microcomputer, a field programmable array, a programmable logic unit, a microprocessor or any other device capable of responding to and executing instructions in a defined manner. The processor may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, the processor may include multiple processors or a controller. In addition, different processing configurations are possible, such a parallel processors.

As a non-exhaustive illustration only, a terminal or device described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

It is to be understood that in the embodiment of the present invention, the operations in FIGS. 4 and 5 are performed in the sequence and manner as shown although the order of some operations and the like may be changed without departing from the spirit and scope of the described configurations. In accordance with an illustrative example, a computer program embodied on a non-transitory computer-readable medium may also be provided, encoding instructions to perform at least the method described in FIGS. 4 and 5.

Program instructions to perform a method described in FIGS. 4 and 5, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of non-transitory computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable recording mediums. Also, functional programs, codes, and code segments for accomplishing the example embodiments disclosed herein may be easily construed by programmers skilled in the art to which the embodiments pertain based on and using the flow diagrams and block diagrams of the figures and their corresponding descriptions as provided herein.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method providing content by a node in a network, the method comprising:
receiving, from a content requesting node in the network, a request for the content;
determining whether to verify the content based on information;
transmitting the content to the content requesting node without verifying the content in response to the determining; and
verifying the content and transmitting the content to the content requesting node in response to the determining.

2. The method of claim 1, wherein the determining comprises determining that the content is not to be verified in response to the information indicating that the content requesting node is an only node requesting the content.

3. The method of claim 1, wherein the determining comprises determining that the content is to be verified in response to the information indicating that the content requesting node and another node are requesting the content.

4. The method of claim 1, wherein the network is a network of infrastructure-based content centric networking (CCN), and the node is a CCN router.

5. The method of claim 1, wherein the network is an adhoc content centric networking (CCN), and the node is a caching node.

6. The method of claim 1, wherein the information comprises information about a popularity of the content.

7. The method of claim 6, further comprising:
determining the popularity based on a number of nodes requesting the content from the node in the network.

8. The method of claim 7, wherein
the node calculates the number of nodes requesting the content from the node based on a pending interest table (PIT), and
each entry on the PIT comprises a name of content corresponding to respective entries, a list of at least one face of the node to which the request for the corresponding content is made, and a message authentication code (MAC) key for the request for the corresponding content transmitted via each of the at least one face.

9. The method of claim 1, wherein the determining comprises
determining the content is to be verified in response to a number of nodes requesting the content from the node being greater than a predetermined value, and determining the content is not to be verified in response to the number of nodes requesting the content from the node being less than the predetermined value.

10. The method of claim 1, wherein the verifying of the content and transmitting of the content comprises
performing signature verification of the content,
determining whether the content is valid based on the signature verification,
generating a message authentication code (MAC) of the content, and
transmitting the content and the MAC to the content requesting node.

11. The method of claim 10, wherein
the generating of the MAC of the content comprises generating MACs of the content using MAC keys for the nodes requesting the content, and
the transmitting of the content and the MAC to the content requesting node comprises transmitting the generated MACs to the content requesting node.

12. The method of claim 1, wherein the request for the content comprises a name of the content, and a value obtained by encoding an MAC key for the content requesting node through use of a public key of the node.

13. A non-transitory computer-readable storage medium comprising a program comprising instructions to cause a computer to perform the method of claim 1.

14. A node in a network, comprising:
a networking unit configured to receive a request for content from a content requesting node in the network; and
a processor configured to determine whether to verify the content based on information,
wherein, in response to the processor not verifying the content, the networking unit is configured to transmit the content to the content requesting node, and
wherein, in response to the processor verifying the content, the networking unit is configured to transmit the content to the content requesting node.

15. The node of claim 14, wherein the processor determines that the content is not to be verified in response to the information indicating that the content requesting node is an only node requesting the content.

16. The node of claim 14, wherein the processor determines that the content is to be verified in response to the information indicating that the content requesting node and another node are requesting the content.

17. The node of claim 14, wherein the information about the content is related to popularity of the content.

18. The node of claim 17, wherein the popularity is determined based on a number of nodes requesting the content from the node in the network.

19. The node of claim 14, wherein the processor is configured to determine the content is to be verified in response to a number of nodes requesting the content from the node in the network to be greater than a predetermined value, and determine the content is not to be verified in response to the number of nodes requesting the content from the node in the network being less than the predetermined value.

20. The node of claim 14, wherein in response to the content being determined to be verified, the processor is configured to perform signature verification of the content, determine whether the content is valid based on the signature verification, and generate a message authentication code (MAC) for the content, and
the networking unit is configured to transmit the content and the MAC to the content requesting node.

21. The node of claim 20, wherein the processor generates MACs of the content using MAC keys for the nodes requesting the content from the node, and
the networking unit transmits the generated MACs to the content requesting node.

22. The node of claim 14, wherein the networking unit requests the content from a source node in the network, and receives the content from the source node.

23. A method using content by a node in a network, the method comprising:
determining whether the content is verified in advance;
selecting a method to determine whether the content is valid based on a result of the determination, and determining whether the content is valid based on the selected method; and
playing the content in response to the content being determined to be valid.

24. A non-transitory computer-readable storage medium comprising a program comprising instructions to cause a computer to perform the method of claim 23.
